(19) United States
(12) Patent Application Publication
(10) Pub. No.: US 2023/0151876 A1
(43) Pub. Date: May 18, 2023

(54) CONTINUOUSLY VARIABLE TRANSMISSION WITH RADIAL DRIVE

(71) Applicant: VARIBOX IP (PTY) LIMITED, Randburg (ZA)

(72) Inventor: Johannes Jacobus NAUDE, Randburg (ZA)

(21) Appl. No.: 17/251,372

(22) PCT Filed: Jun. 14, 2019
(86) PCT No.: PCT/IB2019/054986

§ 371 Date: Dec. 11, 2020

(30) Foreign Application Priority Data
Jun. 15, 2018 (ZA) 2018/03995

(51) Int. Cl. F16H 15/12; F16H 37/02

(52) U.S. Cl. CPC F16H 15/12; F16H 37/021; F16H 2037/028

(57) ABSTRACT

This invention provides a continuously variable transmission (CVT) system using variable disk friction drive. The CVT system comprises a variator (17) including a roller (216), having a cam follower (243; 247), which is radially displaceable from a central axis and mounted in friction drive contact with a drive disk (15); and a rotatable spiral cam (181 ) including a spiral cam cavity (301) arranged such that the roller (216) and the cam follower (243; 247) protrudes through the spiral cam cavity (301), the spiral cam (181) being rotatable about a central axis to radially displace the roller (216). The invention includes a three-mode synchronous system adapted to cooperate with the variator (17).

### FIELD OF THE INVENTION

This invention relates to a continuously variable transmission system using variable disk friction drive and a three-mode synchronous system suitable for use in automotive transmission and in other applications requiring a variable mechanical drive.

### BACKGROUND TO THE INVENTION

The current invention relates to improvements over PCT patent application number WO2017143363. The improvements are related to a ratio changing mechanism, as well as extension of ratio range in a three-mode synchronous manner. The improvements are further related to simplify the design to facilitate commercial development and increase mechanical efficiency.

### BRIEF DESCRIPTION OF THE DRAWINGS

An embodiment of the invention is now described by way of example only and with reference to the accompanying drawings in which:

FIG. 1A is a rear elevation of a transmission system according to the invention;

FIG. 1B is a sectional view of a transmission system according to the invention, through section A-A as presented in FIG. 3A;

FIGS. 2A and 2B illustrate front and rear elevations of a variator system according to the invention;

FIGS. 3A and 3B illustrate front and rear elevations of a variator used in the variator system of FIGS. 2A and 2B;

FIG. 4A is a front elevation of a structure unit used in the variator of FIGS. 3A and 3B;

FIG. 4B illustrates a front and rear elevation of a bevel unit used in the structure unit of FIG. 4A;

FIG. 4C is a front elevation of a ratio drive used in the structure unit of FIG. 4A;

FIGS. 5A to 5C illustrate front and rear elevations, as well as a sectional view of a structure body used in the structure unit of FIG. 4A;

FIGS. 6A to 6C illustrate a front elevation, front view and sectional view of a center unit used in the structure unit of FIG. 4A;

FIGS. 6D and 6E illustrate a front and rear elevation of a radial shaft used in the variator of FIGS. 3A and 3B;

FIGS. 7A to 7D illustrate a top and bottom elevation, a rear view and a sectional view of a follower unit used in the variator of FIGS. 3A and 3B;

FIG. 8A is a front elevation of a spiral cam used in the variator of FIGS. 3A and 3B;

FIGS. 8B and 8C illustrate a rear elevation and sectional view of a variator input shaft used in the variator of FIGS. 3A and 3B;

FIGS. 9A and 9B illustrate a front elevation and sectional view of a front disk unit of the transmission system of FIG. 1B;

FIGS. 10A and 10B illustrate a front elevation and sectional view of a rear disk unit of the transmission system of FIG. 1B;

FIGS. 11A and 11B are front and rear elevations of a spring unit of the transmission system of FIG. 1B;

FIGS. 13A and 13B illustrate a front and rear elevation of a front casing of the transmission system of FIG. 1A;

FIGS. 14A and 14B illustrate a front and rear elevation of a rear casing of the transmission system of FIG. 1A;

FIGS. 15A to 15D illustrate a front elevation and sectional view of a three-mode system in accordance with the invention, with front elevations of various system components of the three-mode system;

FIGS. 16A and 16B illustrates a front and rear elevation of a mode casing;

FIG. 17Ais a sectional view of the transmission system of the invention, through section G-G as presented in FIG. 16B; and

FIGS. 17B to 17E are sectional detailed views of a selector unit in neutral and mode 1 to 3 positions.

### DETAILED DESCRIPTION OF THE PREFERRED EMBODIMENT

### Transmission System 1 of the Invention

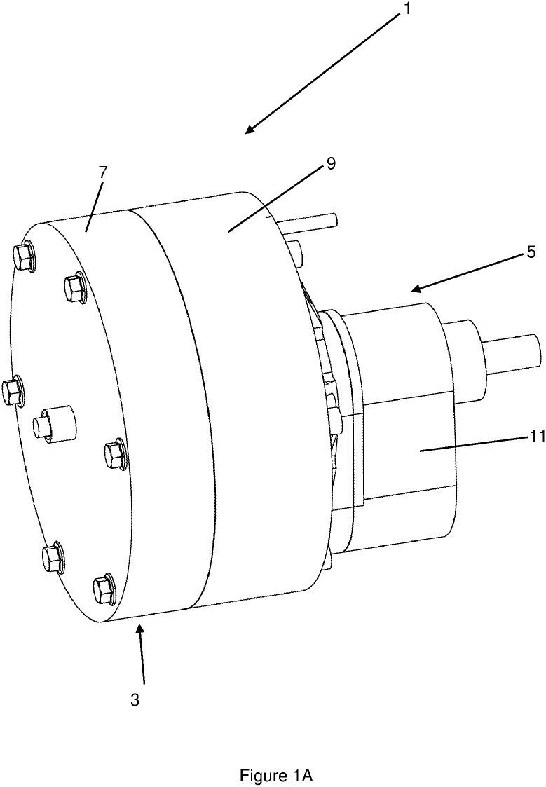

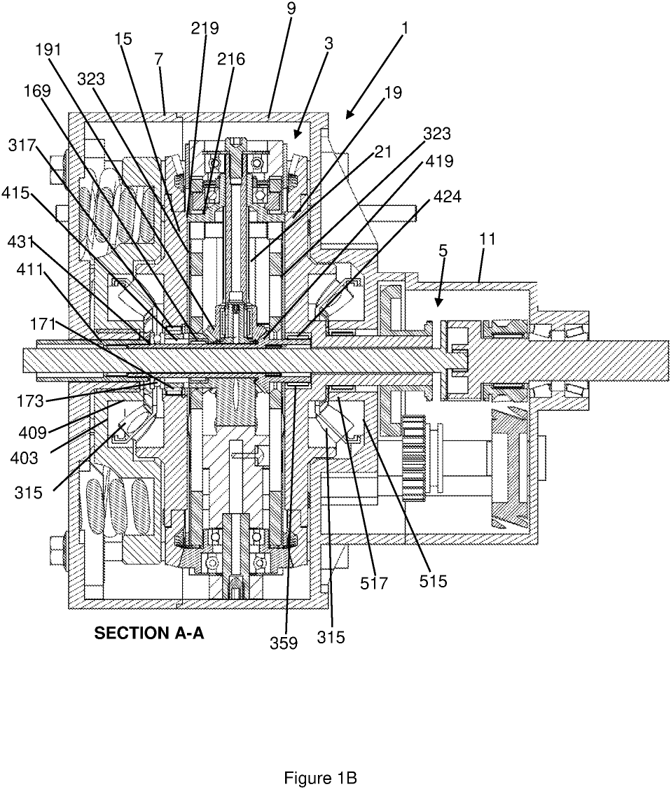

FIG. 1A presents the transmission system 1 of the invention. The transmission system 1 includes a variator system 3 and a three-mode system 5. The transmission system of the invention 1 is contained in a front casing 7, a rear casing 9 and mode casing 11.

### Variator System 3

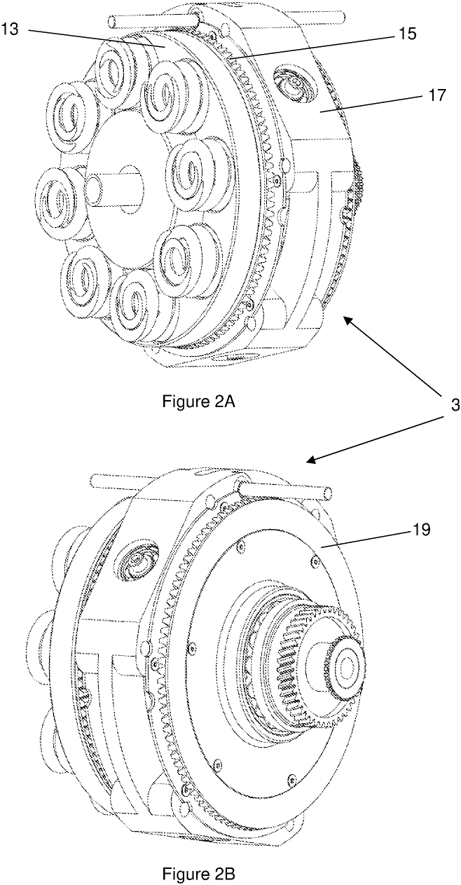

The variator system 3, as can most clearly be seen in FIG. 2, includes a spring unit 13, a front disk unit 15, a variator 17 and a rear disk unit 19.

### Variator 17

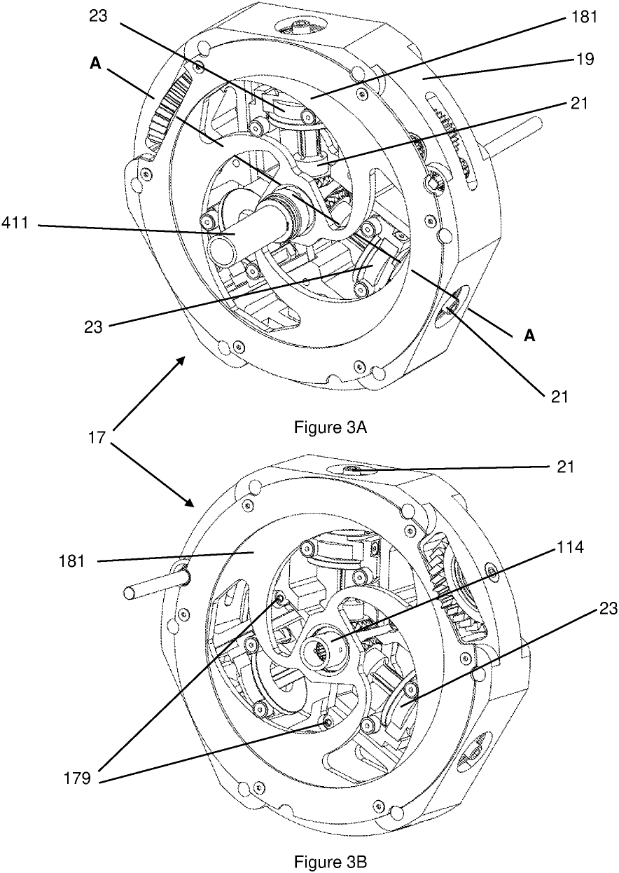

The variator 17, as can most clearly be seen in FIG. 3, includes a structure unit 19, three radial shafts 21, three follower units 23, two spiral cams 181, and a variator input shaft 411.

### Structure Unit 19

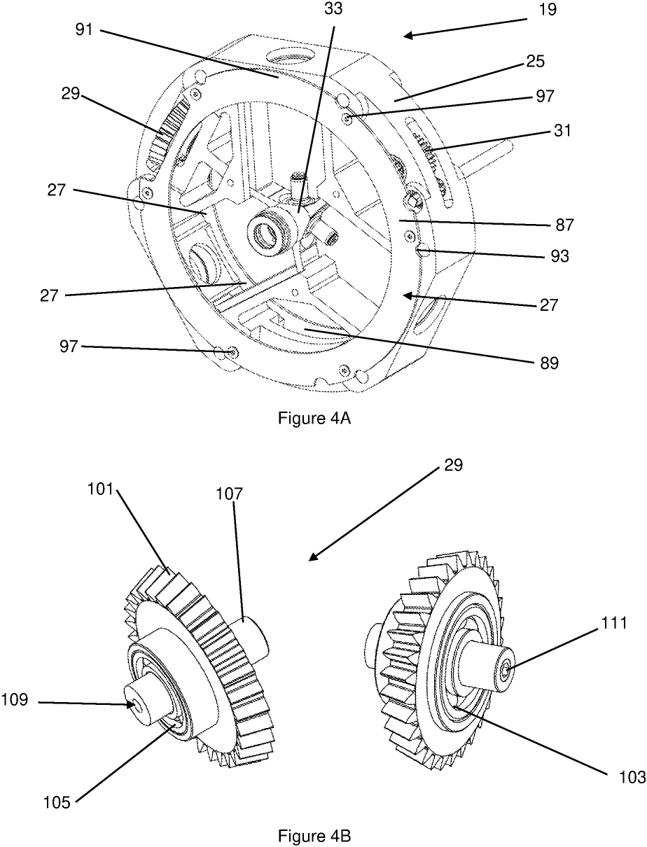

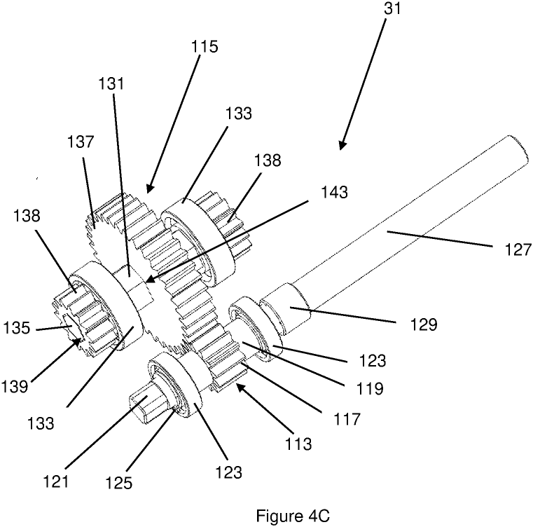

Structure unit 19, as can most clearly be seen in FIG. 4A, includes a structure body 25, a bevel unit 29, two spiral guides 27, a ratio drive 31 and a center unit 33.

### Structure Body 25

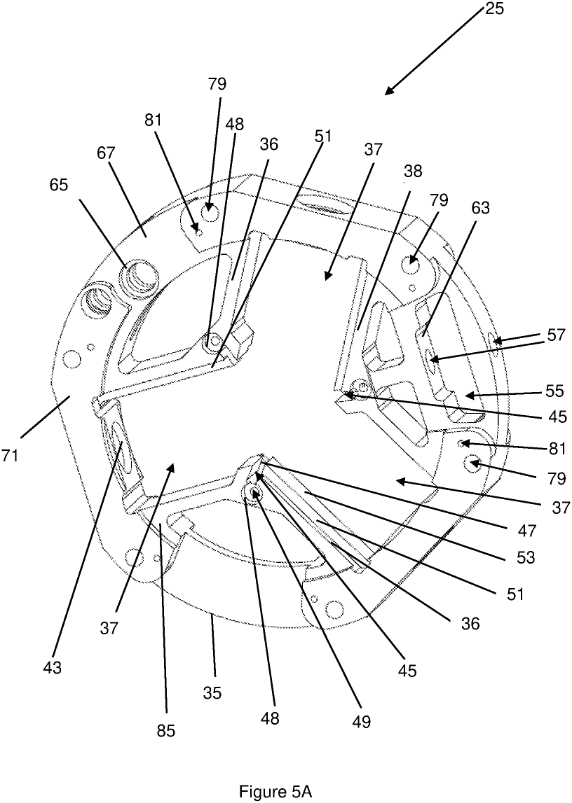

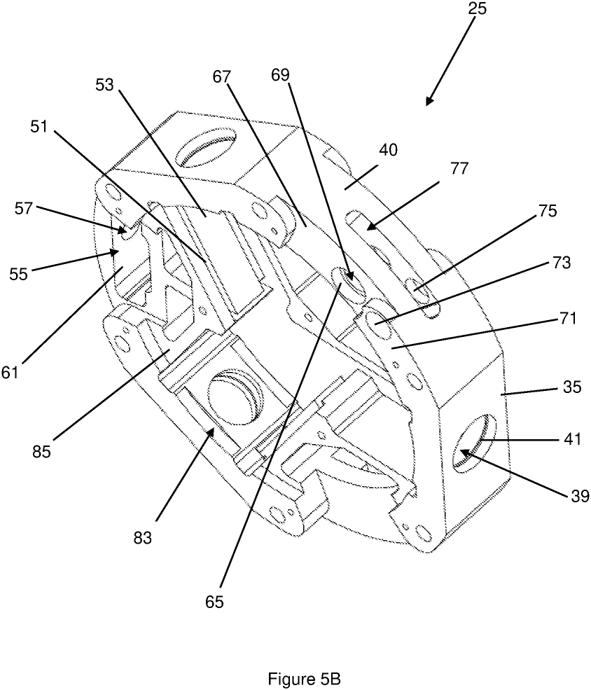

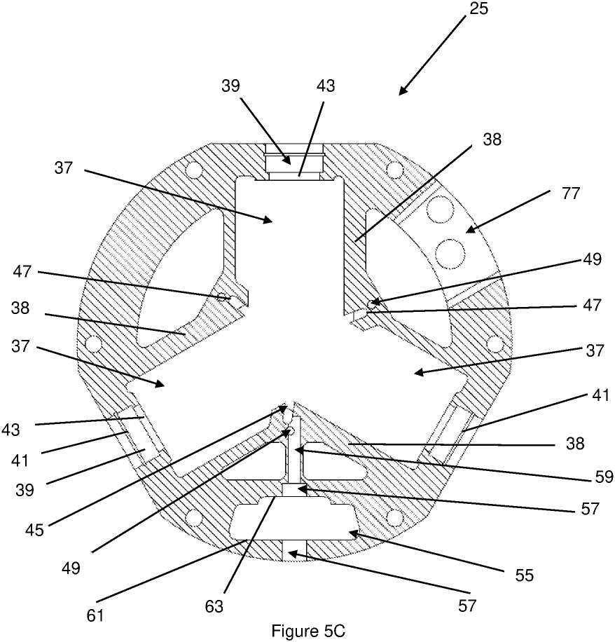

The structure body 25, as can most clearly be seen in FIG. 5, includes a circular-like body 35 including three identical cut-out formations 37, radially spaced evenly at 120 degrees apart. Each cut-out formation 37 terminates at a rim of the body 35 in a bearing pocket 39 with c-clip groove 41 and support rim 43. Each cut-out formation 37 is bordered at either side thereof by two parallel rib formations 36 extending partially inwardly from the rim of the body 35 towards input shaft 411 axis. Neighbouring rib formations 36 between neighbouring cut-out formations 37 are angularly disposed relative to each other so that such neighbouring rib formations 36 join each other to form a substantially triangular configuration 38 with the rim of the body 35.

At an apex of the substantially triangular configuration 38 is a rounded slot 45 which terminates in a slot bottom 47 including a threaded support hole 49 adjacent the slot 45, and an enlarged blind hole 48 which is arranged concentric with support hole 49, and on one side extending into slot 45. One rib formation 36 bordering each cut-out formation 37 also includes a guide face 53, extending the length of the rib formation 36, and two guide steps 51 extending parallel to the guide face 53 on either side thereof and along one side of the cut-out formation 37.

The structure body 25 includes a bevel cut-out 55 configured within one of the substantially triangular configurations 38 between two adjoining rib formations 36 and the rim of the body 35. The bevel cut-out 55 has a top face 61 and bottom face 63 and includes a blind radial pin hole 57, narrowing down to a blind oil hole 59 extending radially inwardly from the bevel cut-out 55 and terminating into slot 45.

The body 35 includes two rim faces 67, 71 arranged at opposite sides of the rim of the body 35. Each face 67, 71 comprises three raised outer faces 71 which interruptedly extends about the circumference of the rim, and three recessed stepped faces 67 extending between neighbouring outer faces. At one substantially triangular configuration 38, the rim of the body 35 includes a radial slot 77 extending through the rim parallel to the rim faces 67, 71 so as to define two parallel rim flanges 40. Each rim flange 40 includes a bearing pocket 65 and a concentric, smaller diameter hole 69 extending through the rim flange 40. The holes 69 protruding through the two rim flanges 40 are aligned. The holes 69 protrude through the recessed step faces 67 of the rim. Each rim flange 40 also includes a bearing pocket 73 and a concentric, smaller diameter hole 75 extending through the rim flange 40 and arranged parallel to and adjacent holes 69. The holes 75 protruding through the two rim flanges 40 are aligned. The holes 75 protrude through the raised outer faces 71 of the rim.

On its outer face 71, the body 35 includes 3 evenly spaced sets of two large holes 79 and two threaded small holes 81 arranged adjacent the large holes 79, the sets of holes 79, 81 being symmetrical with the axis of the respective bearing pockets 39. Holes 79 and 81 protrude through the outer face 71 on one side of the rim of the body 35 through to the outer face 71 on the other side of body 35.

On either side of the body 35, faces 71 include a radially inwardly facing, circular cut-out step 83, configured concentric with body 35, creating spiral face 85.

The remainder of features in the body 35 are for weight reduction and clearance purposes with other parts and are not further elaborated on.

### Bevel Unit 29

Bevel unit 29, as can most clearly be seen in FIG. 4B, includes a bevel gear 101 with bearing pockets for locating ball bearings 103 and 105 on either side of the bevel gear 101. A locating centre pin 107 extends through the ball bearings 103, 105 and bevel gear 101 such that the bevel gear 101 is rotatable about the locating centre pin 107. Center pin 107 includes a center oil hole 109 including a radial hole (not shown) in between bearings 103 and 105 to feed oil to the bearings. On one end, hole 109 is plugged with a grub screw 111. In the assembled structure unit 19 (FIG. 4A), bevel unit 29 is located within bevel cut-out 55 (FIG. 5) with pin 107 mating with radial pin hole 57, while the two opposite faces of bearings 103 and 105 are located against faces 61 and 63 respectively.

### Spiral Guide 27

The spiral guide 27 (FIG. 4A) includes a circular ring plate body 87 with an inner face 89 facing the structure body 25 and outer face 91 facing away from the structure body 25. The spiral guide 27 includes semi-circle holes 93, which are arranged concentric with holes 79 in the structure body 25, and countersunk holes (not shown) which are arranged concentric with holes 81 in the structure body 25. Outer face 91 includes a cut-out 99 within an outer periphery of the spiral guide 27 to allow for clearance of bevel gear 101. In the assembled structure unit 19, a spiral guide 27 is bolted to both sides of the rim of body 35 via countersunk bolts 97 in holes 81.

### Ratio Drive 31

The ratio drive 31, as can most clearly be seen in FIG. 4C, includes a ratio input 113 and spiral drive 115. The ratio input 113 includes a spur gear 117 with a stepped shaft 119 extending from each side of the spur gear 117, terminating at one end of the shaft 119 in a square drive 121 and at an opposite end of the shaft 119 in an input extension shaft 127 such that the square drive 121 engages the input extension shaft 127. A ball bearing 123 is arranged on either side of the spur gear 117. The ball bearings 123 are maintained in position with the aid of c-clips 125. The input extension shaft 127 includes a female square drive 129 on one end to engage and drive the male square drive 121 so as to enable ratio input 113.

The spiral drive 115 includes an axially displaceable spur gear 137, which is mounted to a six-sided shaft 131 via a suitable six-sided center hole 143, the arrangement being such that the six-sided shaft 131 extends from opposite sides of the spur gear 137. The six-sided shaft 131 is stepped down at both ends to a smooth shaft (not shown), which is further stepped down to a six-sided shaft 135. At opposite ends thereof, each shaft 135 terminates in and drives a spur gear 138 via a mating six-sided center hole 139. Locating ball bearings 133 are arranged intermediate the six-sided shaft 131 and the spur gears 138.

In the assembled structure unit 19 (FIG. 4A), spur gear 117 drives spur gear 137 while being positioned in slot 77 (FIG. 5B), while bearings 133 and 123 are located in bearing pockets 65 and 73 respectively, and spur gears 138 are located between the two spiral guides 27.

### Center Unit 33

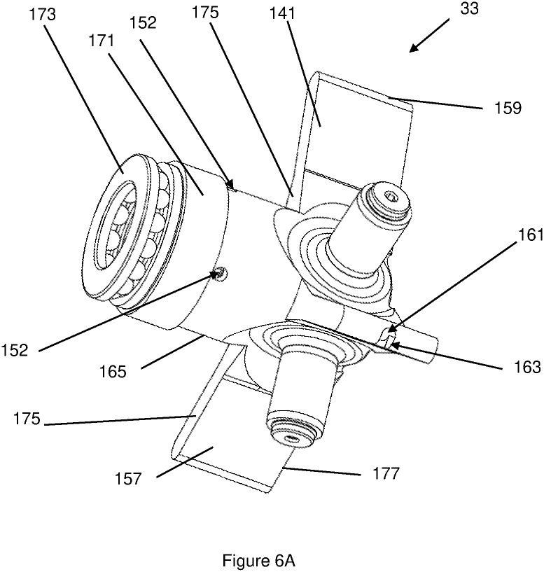

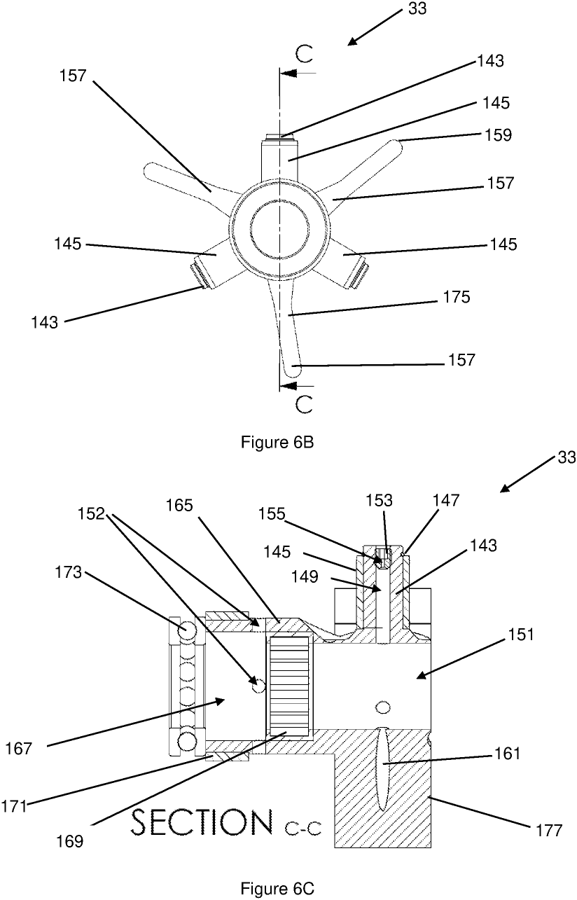

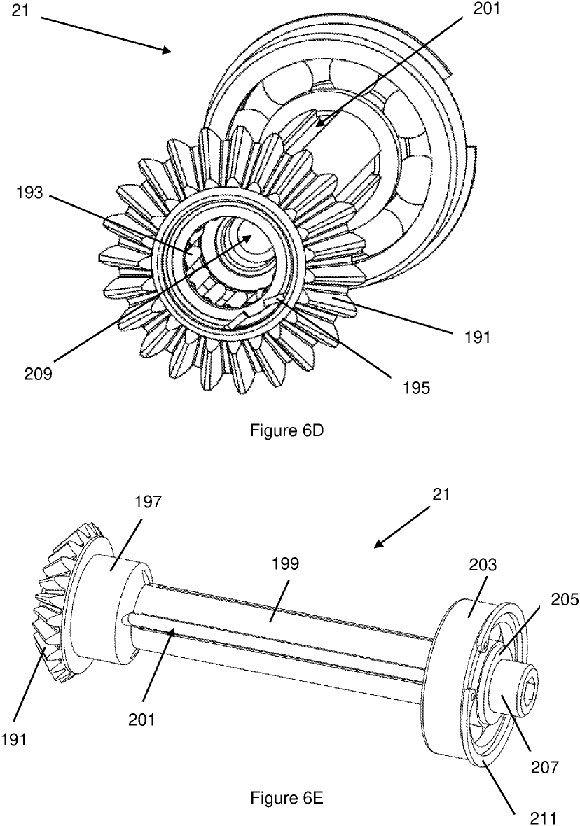

Center unit 33, as can most clearly be seen in FIGS. 6A - 6C, includes a center body 141, with three evenly spaced radial studs 143 extending outwardly from the centre body 141 and each carrying bearing inner ring 145, located via a snap ring 147 in a suitable groove on the stud 143 end. Each radial stud 143 includes a center hole 149 extending into a central bore 151 within center body 141, with a grub screw 153 with central hole 155 located in the end of each stud 143 to act as an oil nozzle. The area around the base of studs 143 are suitably shaped to provide clearance for bevel gear 191 (FIG. 6D).

The center body 141 further includes three equally spaced radial extensions 157 extending from the centre body 141 and arranged between the radial studs 143. Each extension 157 terminates in a rounded rectangular end 159, creating front face 175 and rear face 177. One of the extensions 157 includes a hole 161 extending through the rounded end 159 into central bore 151, with a cut-out 163 to one side. On the front end, center body 141 includes a boss 165 with a bearing pocket 167 which is configured concentric with and adjacent bore 151. A needle bearing 169 is located within bearing pocket 167. Boss 165 includes a step on its front end for locating bearing inner ring 171 and on its front face locates thrust bearing 173 and four oil holes 152 extending into bearing pocket 167.

In the assembled structure unit 19 (FIG. 4A), center unit 33 is located within structure body 25 such that its rounded rectangular ends 159 mate with complimentary slots 45 (FIG. 5A), while front faces 175 are located against slot bottoms 47. Center unit 33 is orientated in such a way that cut-out 163 is positioned alongside oil hole 59 (FIG. 5C) to make oil flow from the center bore 151 to oil hole 109 possible. Center unit 33 is secured with 3 bolts 179 (see FIG. 3) in support hole 49, with the bolt heads inside blind hole 48, while the bolt rim locates against face 177.

### Radial Shafts 21

The radial shafts 21 (FIGS. 3A and 3B), as can most clearly be seen in FIG. 6D en 6E, each includes an elongate shaft 199 with 4 circumferentially equally spaced square grooves 201 extending the length of the shaft 199 and a central bore 209 extending through the shaft 199. The shaft 199 terminates at one end thereof in a boss 197 of increased diameter and a bevel gear 191, including a needle bearing 193 in its central bore, secured via snap ring 195 in a suitable groove to the shaft 199. The shaft 199 terminates at an opposite end thereof in a location bearing 203, maintained in place with a washer 205 and bolt 207 threaded into the central bore 209. A c-clip 211 bears against an outer periphery of bearing 203.

In the assembled variator 17 (FIGS. 3A and 3B), radial shafts 21 are connected to the centre unit 33 such that, at one end of the shaft 21, needle bearing 193 of shaft 21 rotatably engages bearing inner ring 145 of the centre unit 33, while at an opposite end of the shaft 21, locating bearing 203 locates in bearing pocket 39, radially securing it to support rim 43 via c-clip 211 engaged in c-clip groove 41.

### Follower Unit 23

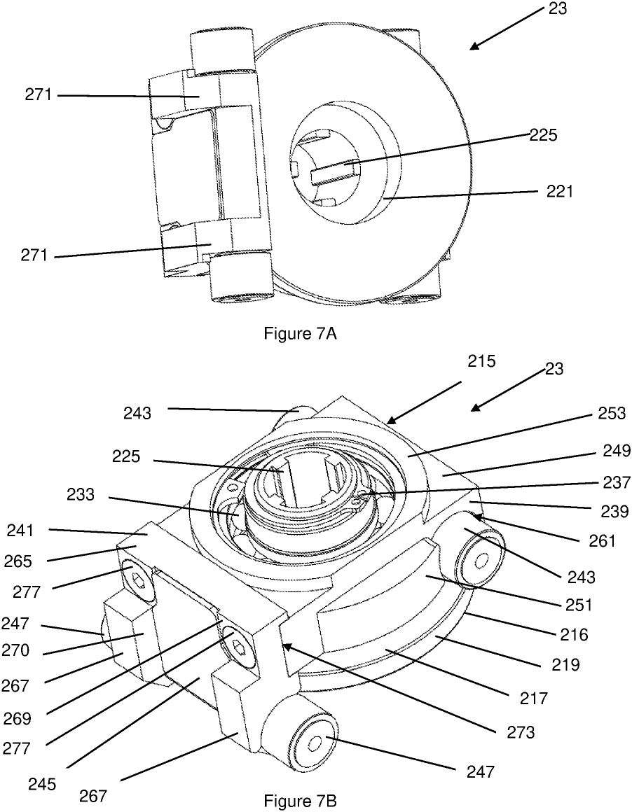

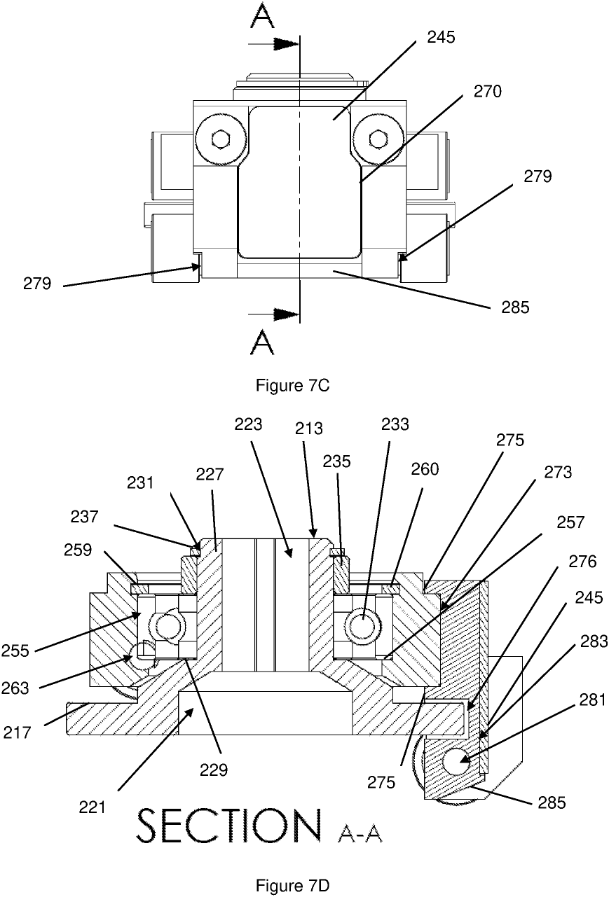

The follower units 23, as can most clearly be seen in FIG. 7, are slidingly mounted to radial shafts 21. Each follower unit 23 includes a traction roller unit 213 and a follower housing unit 215.

The traction roller unit 213 includes a roller 216 including a disk 217 with outer drive rim 219, a center bore 221 narrowing down to a splined hole 223 including 4 internal square splines 225 inside a bush 227, including a step 229 and a c-clip groove 231 at the end of the bush 227. A ball bearing 233 is located about bush 227 between step 229 and a spacer 235 which is located on the other side against c-clip 237 located in c-clip groove 231.

Follower housing unit 215 includes a roller housing 239, a slider 241, two top cam followers 243, two bottom cam followers 247 and a slide plate 245. The cam followers 243 and 247 are of the rotating type which includes a needle bearing around an integrated center threaded shaft for mounting purposes. A typical standard bearing supplier part number is SKF KRV16 for clarity purposes.

The roller housing 239 includes a rectangular body 249 including circular formations 251 on each side, a semi-circular boss 253 on top, a central bore 255 with an internal step 257 at the bottom, and a c-clip groove 259 locating c-clip 260 at the top of the bore 255. On both the front sides, body 249 includes a circular recess 261 with concentric threaded hole 263.

Slider 241 includes a rectangular body 265 including two raised formations 267 on its rear face 269, creating inside slide faces 270, chamfers 271 on bottom corners of the raised formations 267, and a shallow slot 273 on its front face 275. Slider 241 further includes two countersunk holes (not shown) on rear face 269 locating two counter sunk bolts 277, two recesses 279 with threaded concentric holes 281 on either side, a recess 283 locating the complementary shaped slide plate 245, and a chamfer 285 on the rear face 269 bottom. Front face 275 includes a semi-circle groove 276 to provide clearance for disk 217.

In the assembled follower unit 23, the traction roller unit 213 is rotatably located inside the housing unit 215 by locating ball bearing 233 in central bore 255 between internal step 257 and c-clip 260. Slider 241 is attached to follower housing unit 215 by locating the rear of the rectangular body 249 in shallow slot 273 by securing bolts 277 in threaded holes (not shown) in the rear of rectangular body 249. Cam followers 243 are located in threaded holes 263, flush with the base of recess 261, while cam followers 247 are located in threaded holes 281, flush with the base of recess 279.

In the assembled variator 17 (FIGS. 3A and 3B), follower units 23 are axially slidably located within the cut outs 37 of structure unit 19 (FIGS. 5A to 5C). Each follower unit 23 slidably engages a radial shaft 21 such that shaft 199 protrudes through hole 223 of follower unit 23, while roller 216 is driven rotatably by sliding engagement of its square splines 225 with square grooves 201 of shaft 199. The follower units 23 are prevented from rotation relative to the structure unit 19, by the slidable mating of guide steps 51 with slide faces 270 and the mating of guide face 53 with slide plate 245.

### Spiral Cams 181

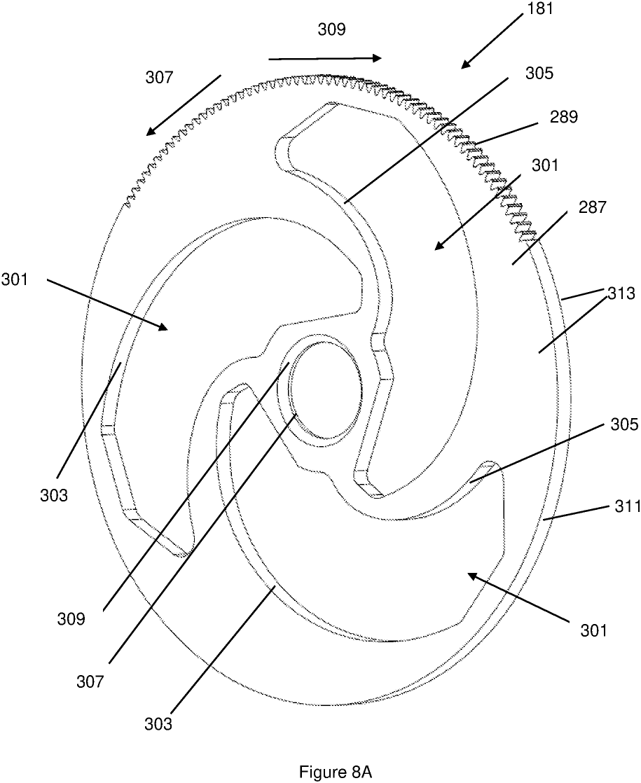

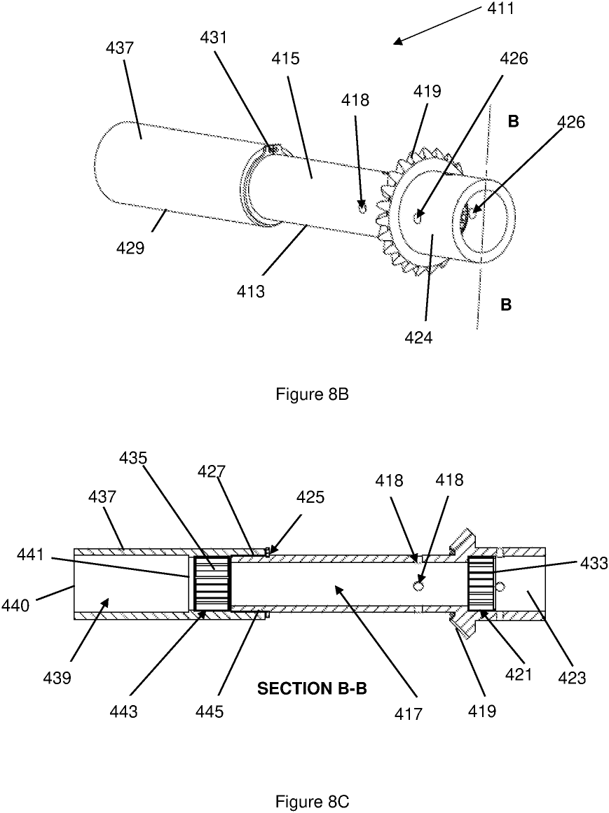

The spiral cam 181, as can most clearly be seen in FIG. 8A, includes a disk 287 including an outer rim face 311, two opposing side faces 313, and spur gear teeth 289 on a section of its perimeter. The spiral cam 181 further includes three evenly spaced cam cut-outs 301, each cut-out 301 including a top cam 303 and a bottom cam 305 with the top and bottom cams joined together with shapes which allows for clearance with other moving parts. Disk 287 includes a center hole 307 with chamfers 309 on either side.

In the assembled variator 17, spiral cams 181 are rotatably located in structure unit 19 with its rim face 311 mating with cut-out step 83 (FIG. 5B) and located between spiral face 85 and the inner face 89 of plate body 87, while its gear teeth 289 meshes and are driven by spur gear 138 of ratio drive 31.

FIG. 1B presents the follower units 23 in their maximum radial position.

In order to regulate the radial position of follower units 23, each cam follower 243, protruding into cut-out 301, engage and roll on top cam 303, while cam followers 247, protruding into cut-out 301, engage and roll on bottom cam 305. As spiral cam 181 is rotated in the direction of arrow 307, top cam 303 in line contact with cam followers 243 is used to position follower units 23 in a radial direction towards the center hole 307 axis. As spiral cam 181 is rotated in the direction of arrow 309, bottom cam 305 in line contact with cam followers 247, is used to position follower units 23 in a radial direction away from the center hole 307 axis.

The profile of the top cam 303 and bottom cam 305 is such that all the cam followers 243 and 247 remain in line contact with the respective cams in all radial positions of the follower units 23. The shape of cut-out 301 is of such a nature that it allows for follower 243, follower 247, roller 216 and circular formations 251 to freely operate within cut-out 301 in all radial positions of follower unit 23.

In cost effective solutions cam followers 247 and 247 may be fixed cam surfaces in sliding contact with top cam 303 and a bottom cam 305.

### Variator Input Shaft 411

The variator input shaft 411, as can most clearly be seen in FIGS. 8B and 8C, includes a bevel gear shaft 413 including a central tube 415 with a central bore 417 and four evenly spaced oil holes 418. Shaft 413 terminates at one end thereof in a bevel gear 419, and a bearing pocket 421 adjacent the bevel gear 419 in an enlarged tube section 423 with outer face 424 including four evenly spaced oil holes 426. At an opposite end thereof, shaft 413 terminates in a c-clip groove 425 and external splines 427 (splines not shown), a connector tube 429, a c-clip 431, a front needle bearing 433 and a rear needle bearing 435. Connector tube 429 includes a tube body 437 including a central bore 439, rear end 440, a step 441, a bearing pocket 443 and internal splines 445 on its end (splines not shown).

In the assembled variator input shaft 411, bevel gear shaft 413 is attached to connector tube 429 via the mating of external splines 427 and internal splines 445 with the front end of connector tube 429 bearing against c-clip 431, which is located in c-clip groove 425, while needle bearing 435 is located in bearing pocket 443 between step 441 and the rear end of bevel gear shaft 413. Needle bearing 433 is located in bearing pocket 421.

In the assembled variator 17, as can most clearly be seen in FIG. 1B, variator input shaft 411 is rotatably located in center unit 33 via the mating of central tube 415 with needle bearing 169 while the c-clip 431 is located against thrust bearing 173. Variator input shaft 411 drives the three radial shafts 21 via the meshing of bevel gear 419 simultaneously with the three bevel gears 191 of radial shafts 21.

### Front Disk Unit 15

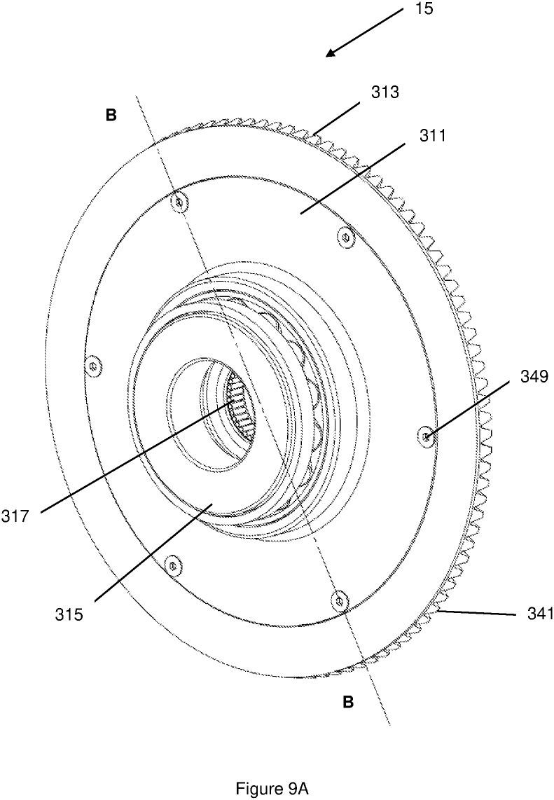

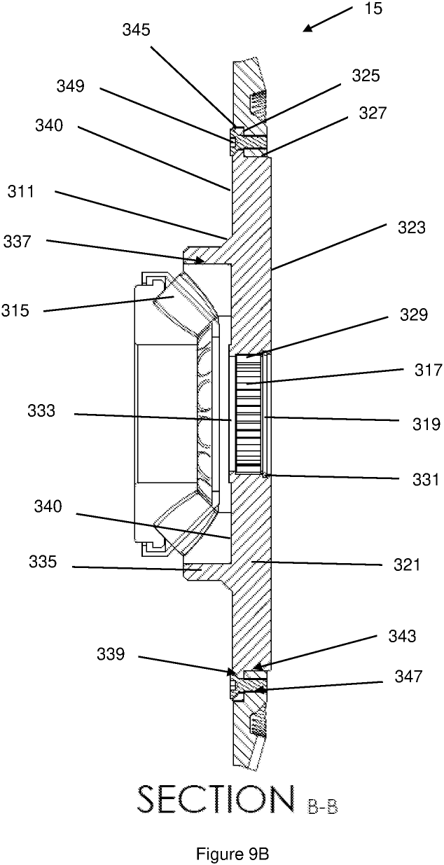

Front disk unit 15, as can most clearly be seen in FIGS. 9A and 9B, includes a front disk 311, a ring bevel gear 313, a spherical thrust bearing 315, a needle bearing 317 and a snap ring 319.

Front disk 311 includes a circular body 321 including a front flat face 323, a rear face 340, a step on its outer rim 327 creating face 325 with six circumferential countersunk holes 339, a center bearing pocket 329 with a snap ring groove 331 on one side and a step 333 on the other side, and a rear circular rim extrusion 335 creating a bearing pocket 337.

Ring bevel gear 313 includes a bevel gear 341, including a center bore 343, located and mating with outer rim 327, a step 345 complimentary shaped and mating with face 325 and six threaded circumferential holes 347 in step 345 concentric with holes 339.

In the assembled front disk unit 15, spherical thrust bearing 315 is located in bearing pocket 337 with its front face against face 340, needle bearing 317 is located in bearing pocket 329 between step 333 and snap ring 319 located in snap ring groove 331, while six countersunk bolts 349 secured in holes 339 and 347 secure ring bevel gear 313 onto front disk 311. For clarity, spherical thrust bearing 315 may be a standard bearing with bearing number SKF 29412 or any other standard thrust bearing like a ball thrust bearing or taper roller bearing.

### Rear Disk Unit 19

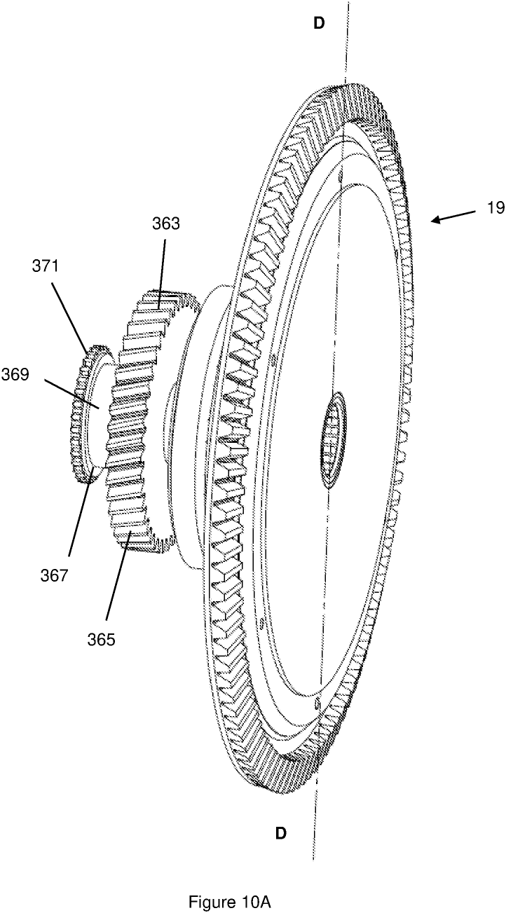

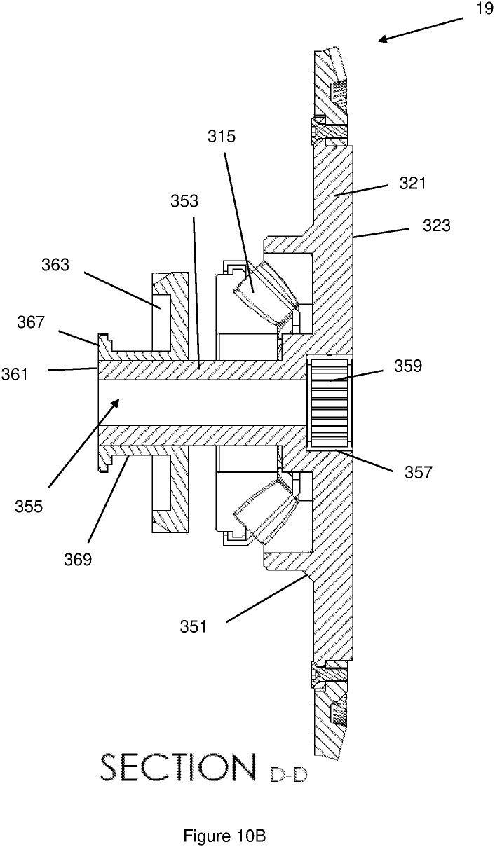

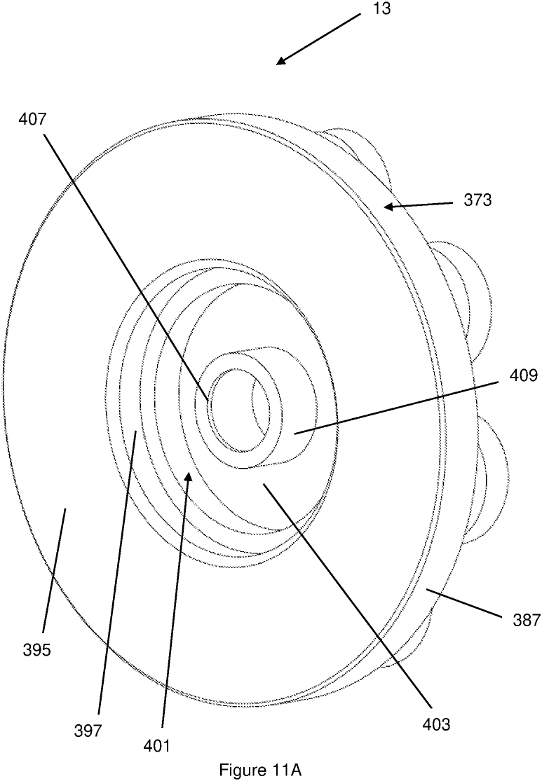

Rear disk unit 19, as can most clearly be seen in FIGS. 10A and 10B, is identical to front disk unit 15 except for the differences presented below. Rear disk unit 19 includes rear disk 351, which is identical to front disk 311, except for the following differences. Body 321 includes a center bore hollow shaft extension 353 with center bore 355 and rear face 361. On front flat face 323, body 321 includes a needle bearing pocket 357 locating needle bearing 359 concentric with center bore 355. Located fixed and flush with face 361 on extension 353, by any drivable suitable means like splines (not shown), is a gear unit 363. Gear unit 363 includes a helical gear 365 fixed to a dog clutch disk 367 via a tube 369. Dog clutch disk 367 includes dog clutch teeth 371 similar to the dog clutch teeth found in automotive manual and automated manual transmissions.

### Spring Unit 13

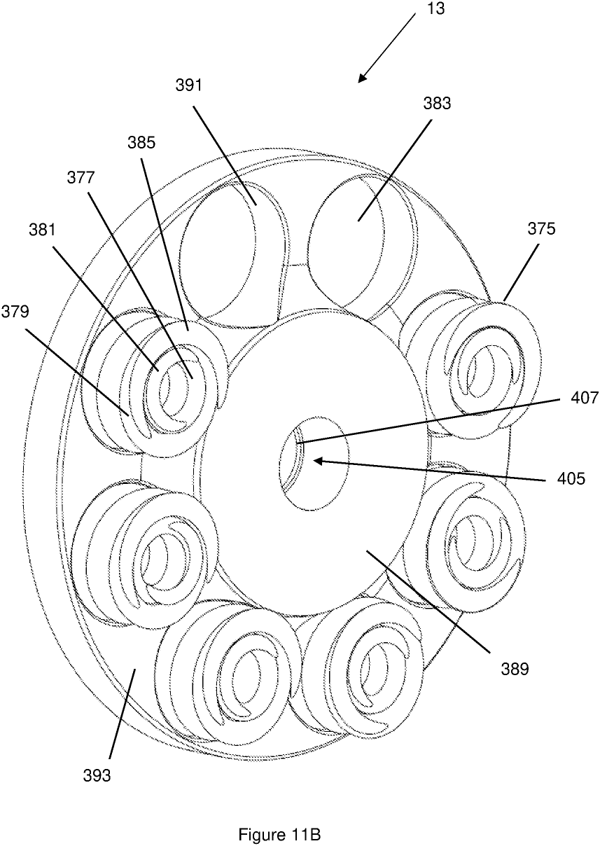

Spring unit 13, as can most clearly be seen in FIGS. 11A and 11B, includes a spring holder 373 and eight spring packs 375, each including an inner compression coil spring 377 with front face 381 and rear face (not shown) located against face 383; and concentric with spring 377 an outer compression coil spring 379 with front face 385 and rear face (not shown) located against face 383. FIG. 11B presents the spring unit 13 with two spring packs 375 hidden for clarity.

Spring holder 373 includes a circular body 387 including on its front face 389, eight evenly spaced spring pockets 391 with bottom faces 383 on a stepped face 393 and a central bore 405 including a step 407. Circular body 387 also includes a rear face 395, including a multi-stepped formation 397 terminating in bearing pocket 401 with bottom face 403 including a boss 409 around central bore 405.

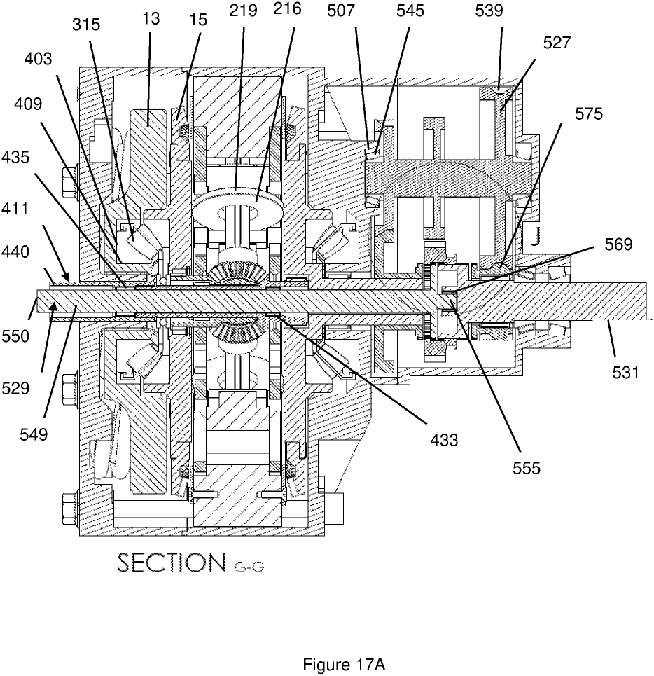

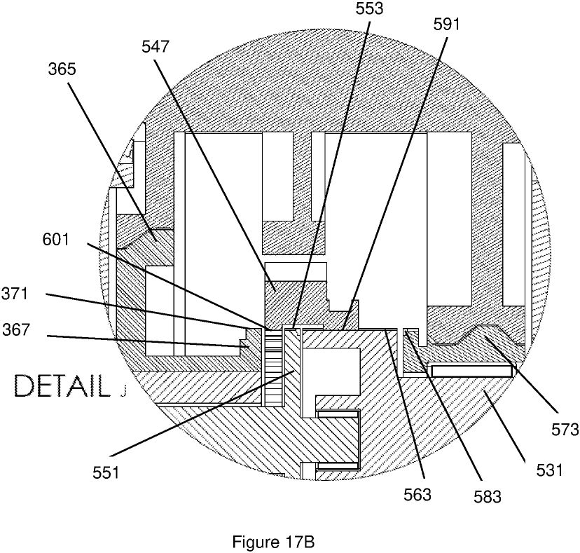

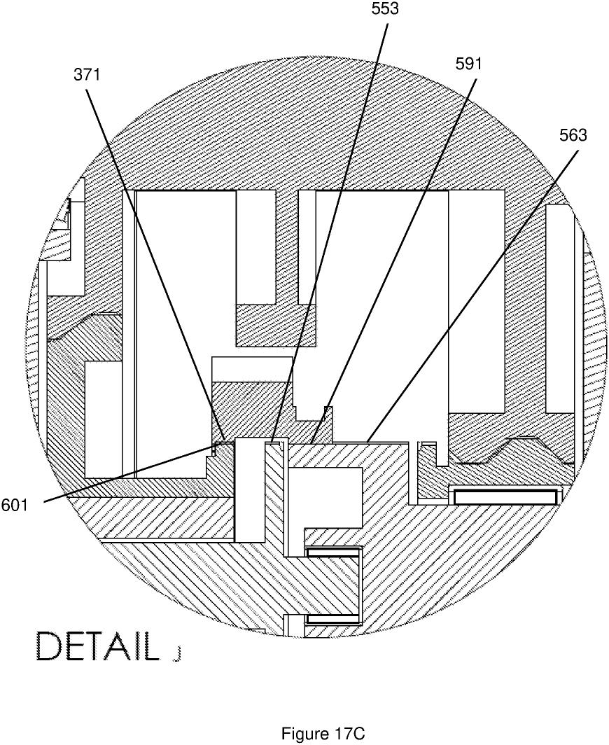

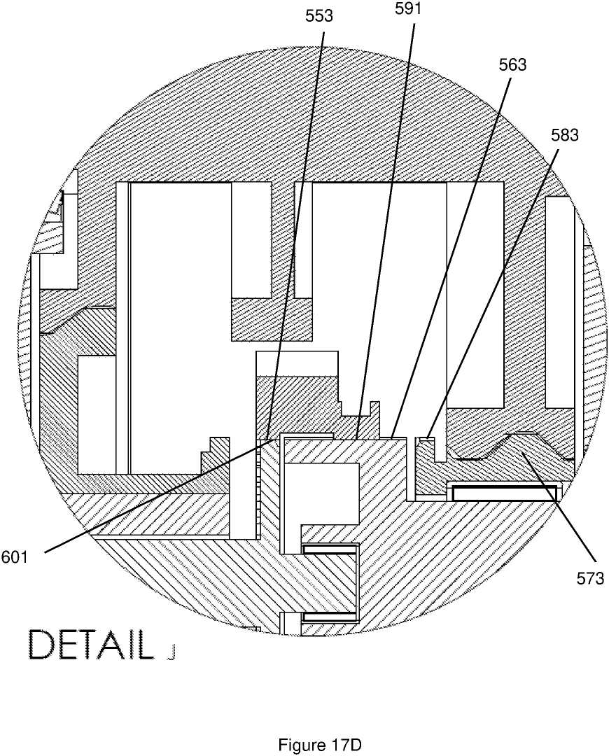

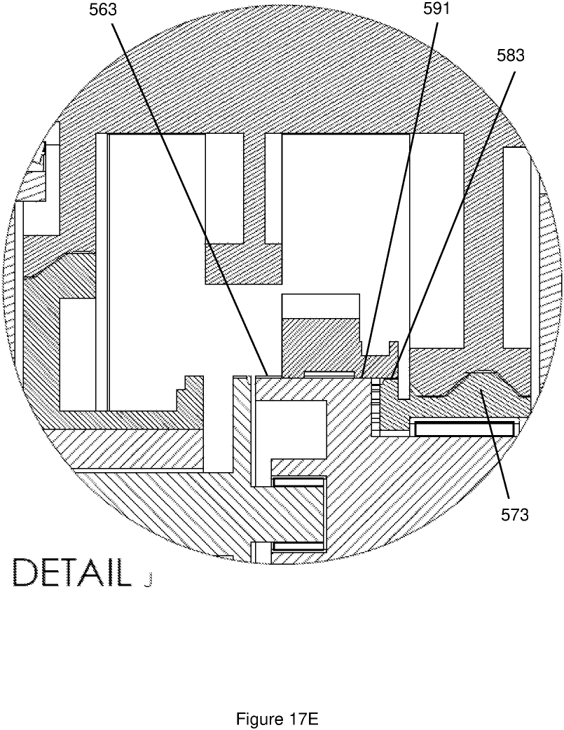

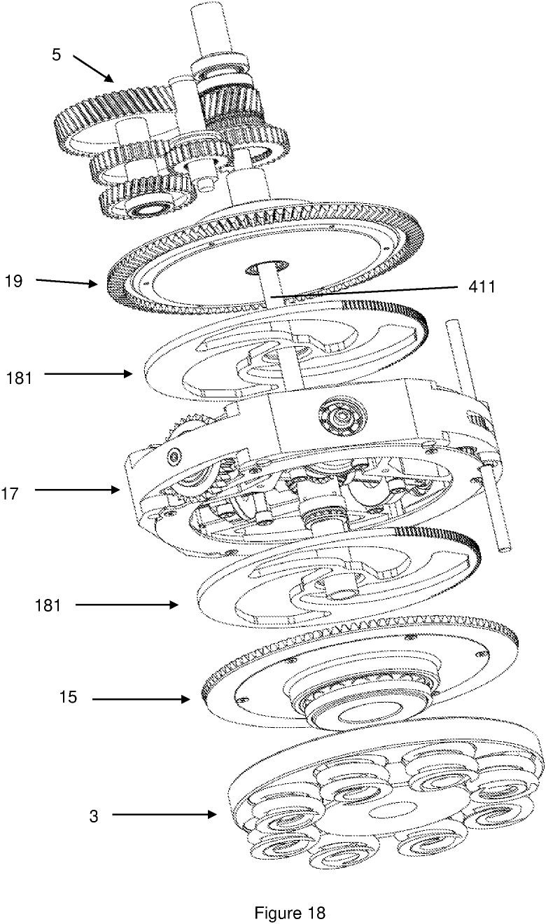

In the assembled variator system 3, as can most clearly be seen in FIG. 1 and FIG. 17A, front disk unit 15 is located rotatably and concentric with spring unit 13 via the location of spherical thrust bearing 315 about boss 409 with its rear face against face 403. Front disk unit 15 is also rotatably located around center unit 33 of variator 17 through mating of needle bearing 317 with inner ring 171, while the front flat face 323 of front disk unit 15 is in traction drive line contact with the outer drive rim 219 of follower unit 23 of variator 17.

Rear disk unit 19 is rotatably and concentric located around the variator input shaft 411 of variator 17 via the mating of outer face 424 of shaft 411 with needle bearing 359 of rear disk unit 19, while the front flat face 323 of rear disk unit 19 is in traction drive line contact with the outer drive rim 219 of follower unit 23 of variator 17.

### Front Casing 7

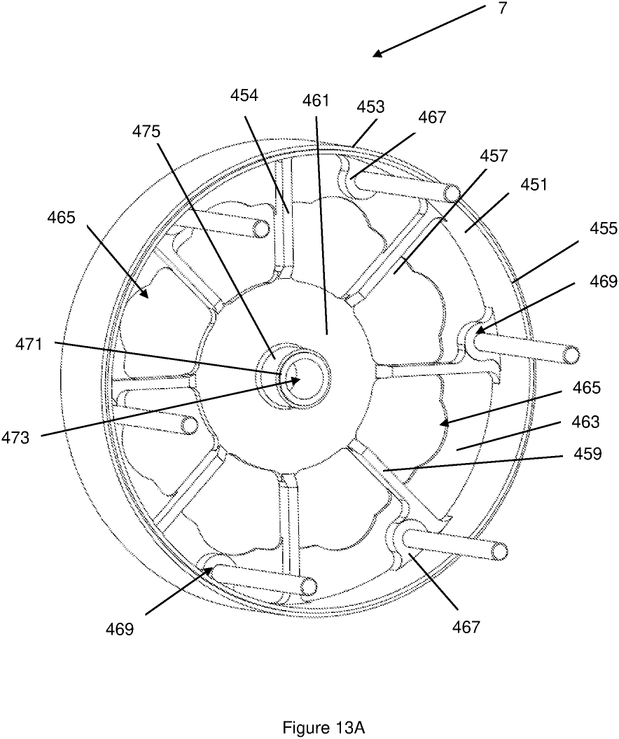

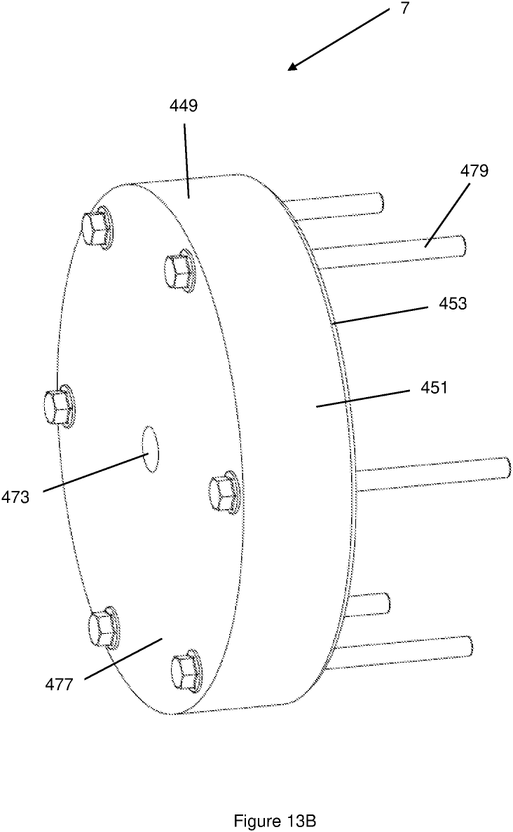

Front casing 7, as can most clearly be seen in FIG. 13, includes a circular body 449 including a rear face 477, a rim 451 with and external step 453 on its front end 455, a bottom face 457 including eight evenly spaced raised ribs 459, a center raised face 461, outer raised faces 463 including semi-circular cut-outs 465, six evenly spaced bosses 467 with center holes 469. Raised face 461 carries a cylindrical extrusion 471 with center bore 473 while an inner ring 475 is located around extrusion 471. Each hole 469 locates a bolt 479 with the bolt 479 heads located against face 477.

### Rear Casing 9

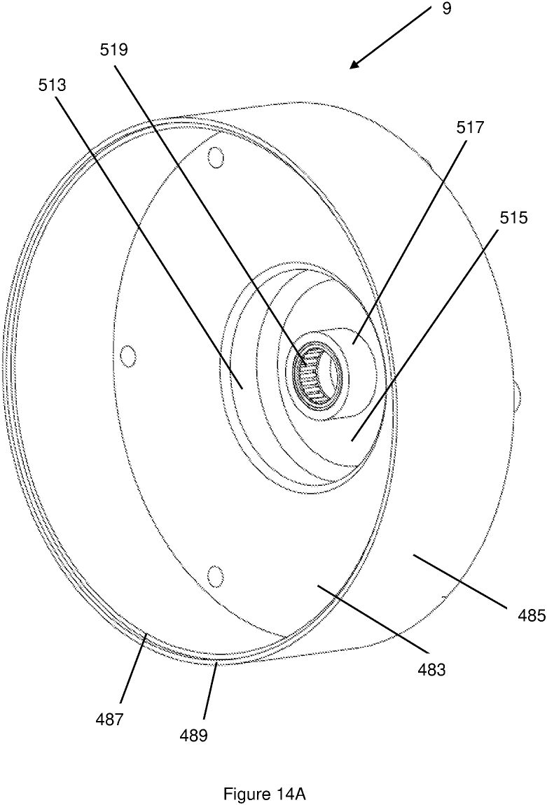

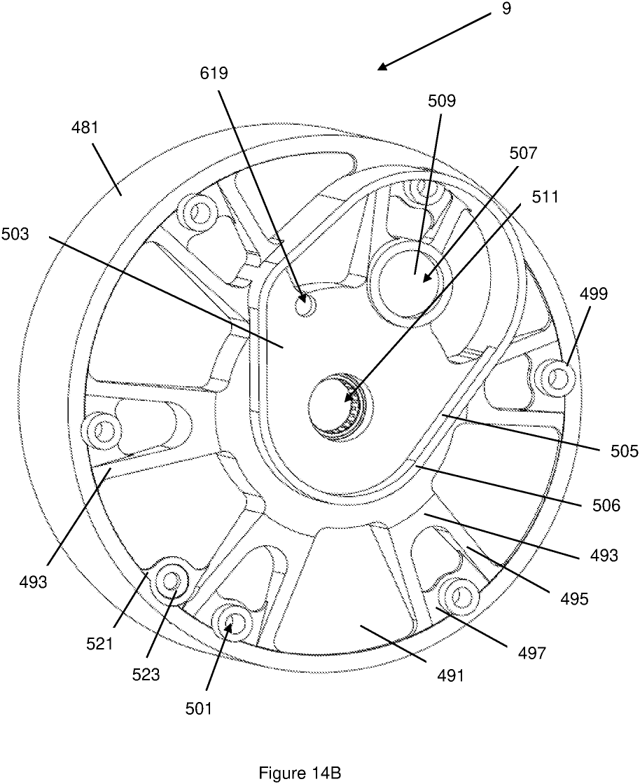

Rear casing 9, as can most clearly be seen in FIG. 14, includes a circular body 481 including a front face 483, a rim 485 with an internal step 487 on its front end 489, a bottom face 491 including six evenly spaced rib formations 493 including two tapered ribs 495, a raised face 497 and a boss 499 with internal threaded hole 501, a raised face 521 with an oil seal pocket and center hole, locating oil seal 523, while the rib formations 493 terminate in a center raised face 503.

Raised face 503 includes a center bore 511, a casing rim 505 extending to face 491 as well as in the opposite direction to terminate in face 506, a rim bearing pocket 507 with bottom face 509 and a blind hole 619. Casing rim 505 is suitably shaped and has sections concentric with bearing pocket 507 and center bore 511 to enclose the components of the three-mode system 5. Front face 483 includes a multi-step formation 513, terminating in face 515 including a boss 517 with its center bore larger and concentric with bore 511, and locating needle bearing 519.

In the assembled transmission system of the invention 1, spring unit 13 is located in front casing 7 with central bore 405 axially slidably located around inner ring 475, while the front face 381 of inner compression coil spring 377 and the front face 385 of outer compression coil spring 379 bear against bottom face 457 while being concentric with circular cut-outs 465. Moreover, rear disk unit 19 is rotatably located in rear casing 9 with the spherical thrust bearing 315 of rear disk unit 19 bearing against face 515 of rear casing 9, while the inner diameter of spherical thrust bearing 315 is located around boss 517 and needle bearing 519 mates rotatably with shaft extension 353.

The front casing 7 and rear casing 9 are clamped together through bolts 479 of the front casing 7 threading into threaded holes 501 of the rear casing 9, while the two complementary peripheral external step 453 and internal step 487 engage each other.

During operation of the transmission system of the invention 1, under the compressive force of the compression coil spring 377 and 379, rollers 216 are clamped in line contact traction drive between the front flat faces 323 of front disk unit 15 and rear disk unit 19.

During operation the variator 17 functions as follows:

The variator input shaft 411 drives the three radial shafts 21 via bevel gear 419 meshing with the three bevel gears 191. The three radial shafts 21 each drive a roller 216 which in turn traction drives both the front disk unit 15 and rear disk unit 19. The rear disk unit 19 serves as an output and the output of the front disk unit 15 is combined with the rear disk unit 19 via bevel unit 29.

The ratio between input shaft 411 and rear disk unit 19 is changed by rotating input extension shaft 127 (via some power source not shown) which rotates the spiral cams 181 via the ratio drive 31. The rotating spiral cams 181 regulate the radial position of the rollers 216 via the follower units 23. The radial position of the rollers 216, and thus its line contact radius on the front disk 311 and rear disk 351 flat front faces 323, is directly related to the ratio between input shaft 411 and rear disk unit 19.

As roller 216 has a tendency to always move by its own force to a larger radius on the front disk unit 15 and rear disk unit 19 during operation, cam followers 247 and bottom cam 305 may be eliminated to simplify the design. The variator system 3 can be used as a stand-alone mechanical variator in industrial and electric vehicle applications.

It is of importance that the traction fluid oil used in the variator system 17 reach all the relevant moving parts, but most importantly ensures an oil film in the line contact traction drive between the roller 216 rim 219 and front disk 15 and rear disk 19 front flat faces 323. To this end, traction fluid oil may be supplied by an external pump through a hole (not shown) in the rear casing 9 to deliver oil to center oil hole 109 (grub screw 111 is removed), which will deliver oil to central bore 151 and central hole 155. From central bore 151 oil is also distributed to oil holes 152, which feeds oil to the base of front disk 15 and to oil holes 426 (via oil holes 418), which feeds oil to the base of rear disk 19. Through the centrifugal force of the rotating front disk 15 and rear disk 19, the oil is then distributed over the whole faces 323 of the respective disks to provide the required oil film. Note that in all the oil flow passages, channels, holes, clearances and nozzles, appropriate restrictions like oil seals or o-rings or nozzle sizes may be employed to optimize the oil flow rate to deliver the oil requirements to all components.

### Three-Mode System 5

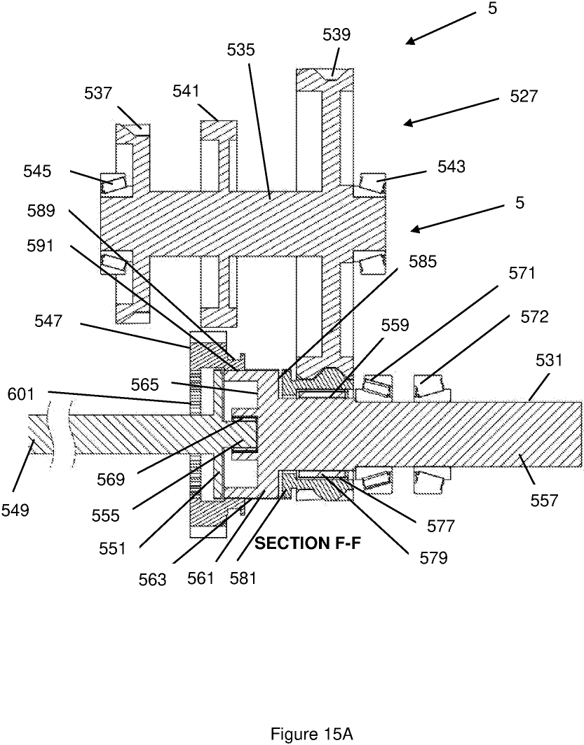

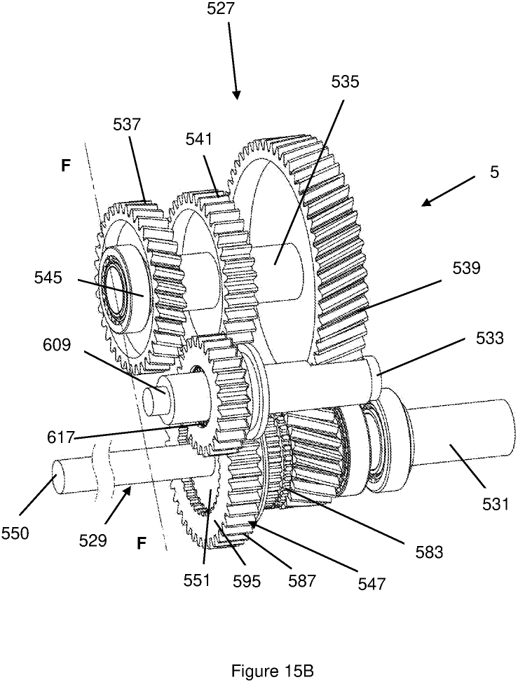

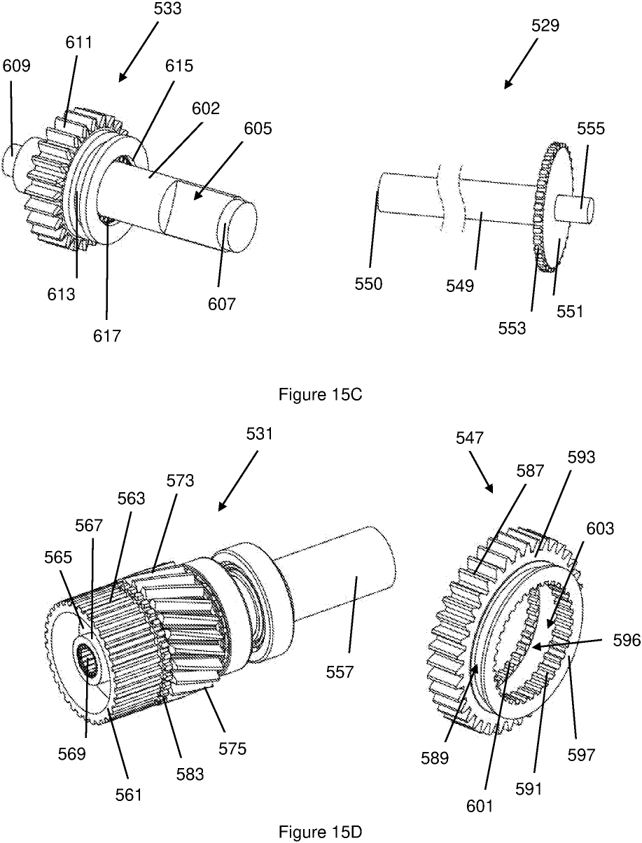

The three-mode system 5, as can most clearly be seen in FIGS. 15A to 15D, includes a mode shaft unit 527, a direct input shaft 529, a transmission out shaft 531, a reverse idler 533 and a selector unit 547.

### Mode Shaft Unit 527

Mode shaft unit 527 includes a shaft 535 terminating at one end in helical gear 537, terminating at an opposite end in helical gear 539, and including spur gear 541 arranged intermediate helical gear 537 and helical gear 539. Each shaft end carries a taper roller bearing 543 and 545.

### Direct Input Shaft 529

Direct input shaft 529 includes a shaft 549, with rear end 550, including a disk 551 carrying dog clutch teeth 553 on its outer rim and shaft extension 555 on its front end.

### Transmission Out Shaft 531

Transmission out shaft 531 includes an output shaft 557 and helical idler 573. Output shaft 557, which locates taper roller bearings 571 and 572, includes a stepped shaft 559 with front face 565 including a boss 561 with front face 585 and dog clutch teeth 563 on its outer rim; as well as an internal boss 567 protruding from face 565, including a bearing pocket locating needle bearing 569. Taper roller bearing 571 is located on one side of helical idler 573 against stepped shaft 559.

Helical idler 573 includes a helical gear 575 including an internal bore 577 on one side, locating needle bearing 579, and on the other side a disk 581 including dog clutch teeth 583 on its rim. Helical idler 573 is rotatably located concentric with stepped shaft 559 via the mating of needle bearing 579 with stepped shaft 559, while being located between taper roller bearing 571 and face 585.

### Selector Unit 547

Selector unit 547 includes a spur gear 587 extending about its circumference, including a front face 593 and a rear face 595. A selector groove 589 extends from front face 593 and terminates in front face 597. A center bore 596 extends through selector unit 547 and includes a first section of internal dog clutch teeth 591 approximate face 597, and a second section of internal dog clutch teeth 601, approximate face 595, identical to and aligned with teeth 591, with a smooth bore 603 intermediate teeth 591 and 601, with bore 603 having a diameter that is larger than the outer diameter of internal dog clutch teeth 591.

### Reverse Idler 533

Reverse idler 533 includes idler shaft 602 including shaft end 607 on one end and shaft end 609 on the opposite end, semi-circular cut-out 605 approximate shaft end 607, a reverse spur gear 611 mounted on shaft 602 including a selector groove 613, a center bore 615 locating needle bearing 617. Reverse spur gear 611 is rotatably and axially slidably located on shaft 602 via the mating of needle bearing 617 with shaft 602.

The profiles and number of teeth of external dog clutch teeth 583, 563, 553 and 371 are identical. The profiles and number of teeth of internal dog clutch teeth 591 and 601 are identical and aligned to enable dog clutch teeth 591 and 601 to slide over dog clutch teeth 583, 563, 553 and 371 and engage them as is common practice in manual and automated manual transmissions. All above dog clutch teeth may include teeth rounding on one or more side to facilitate engagement, which is also common practice in manual and automated manual transmissions.

### Assembled Three-Mode System 5

In the assembled three-mode system 5, as can most clearly be seen in FIG. 17A, direct input shaft 529 is rotatably and concentric located with reference to variator input shaft 411 via the mating of shaft 549 with needle bearings 433 and 435. Transmission out shaft 531 is rotatably and concentric located with reference to variator input shaft 411 via the mating of needle bearing 569 and shaft extension 555. Mode shaft unit 527 is rotatably located in a rear casing 9 via taper roller bearing 545 located in bearing pocket 507, against face 509, while helical gear 539 meshes with helical gear 575. Reverse idler 533 is located in rear casing 9 via the location of shaft end 609 in blind hole 619 orientated in such a way that semi-circular cut-out 605 provide clearance for helical gear 539.

Selector unit 547 and reverse spur gear 611 are independently axially positioned via selector forks and their driving means (not shown) engaging their respective selector grooves 589 and 613 respectively as is common practice in manual and automated manual transmissions

### Mode Casing 11

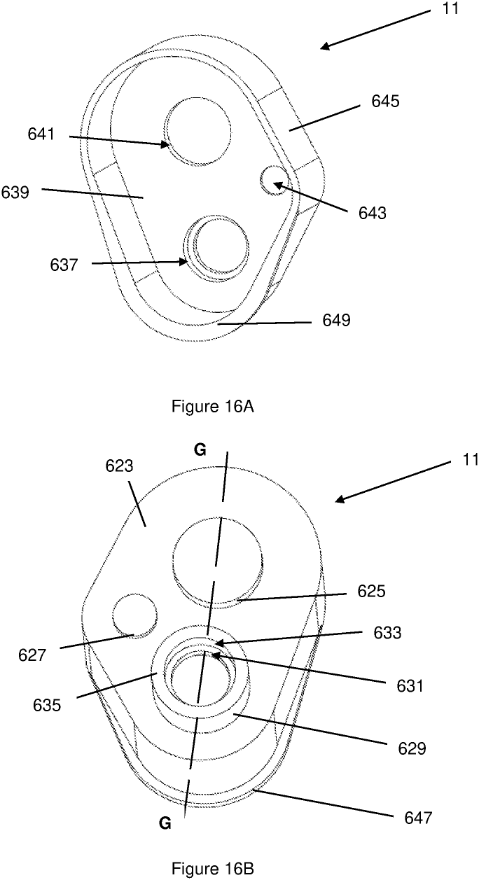

Mode casing 11, as can most clearly be seen in FIG. 16, includes rear face 623 including boss 625, boss 627, boss 629 including a center bore 631, a bearing pocket 633 between the center bore 631 and rear face 635 of boss 629, a bearing pocket 637 between center bore 631 and inner face 639, a bearing pocket 641 inside boss 625 on face 639, a blind hole 643 inside boss 627 on face 639, a casing rim 645 concentrically shaped around boss 625, boss 627, and boss 629 including a lip 647, around boss 629 on the front face 649 of rim 645. The lip 647 and rim 645 is of such a shape that face 649 is complimentary shaped and mates and are located against casing rim 505 face 506 of rear casing 9.

In the assembled transmission system of the invention 1, taper roller bearing 571 of transmission out shaft 531 (FIG. 15A) is located in bearing pocket 637 and taper roller bearing 572 in bearing pocket 633, taper roller bearing 543 is located in bearing pocket 641, while shaft end 607 is located in blind hole 643.

### Transmission System of the Invention 1 Operation

For the explanation below it is assumed that the ratio of the variator 17, that is the ratio between variator input shaft 411 and dog clutch teeth 371 of rear disk unit 19 can be adjusted from 3:1 to 1:1 by rotation of input extension shaft 127. It is also assumed that the gear ratio between helical gear 365 and helical idler 573 via mode shaft unit 527 is 1:3. The position of rollers 216 in FIG. 13 refers to the 1:1 ratio and the position of rollers 216 in FIG. 17A to the 1:3 ratio. However above ratios may be any suitable ratios.

### Single Clutch Embodiment

In this embodiment of the invention 1, the rear end 550 of direct input shaft 529 and rear end 440 of variator input shaft 411 are coupled/fixed together, as well as coupled to a standard automotive automated single clutch system (not shown) as is commonly found in automated manual automotive transmissions. The single clutch system allows for the selective disengagement or partially or full coupling of rear end 550 to the power source via an integrated wet or dry clutch, usually an internal combustion engine in a typical automotive application.

### Selector Unit 547 Position: Neutral

The neutral position of selector unit 547 is presented in FIG. 17B where only dog clutch teeth 591 is engaged with dog clutch teeth 563 and the transmission out shaft 531 is not coupled to any other components and can freely rotate. In this position dog clutch teeth 553 is positioned between dog clutch teeth 371 of rear disk unit 19 and dog clutch teeth 553 without engaging them while reverse idler 533 is in the position of FIG. 15B with its reverse spur gear 611 not meshing with any other gears.

### Selector Unit 547 Position: Mode 1

This presents the pull away mode with the ratio of the variator 17 at 3:1 and the selector unit 547 in the position of FIG. 17C, representing mode 1, where dog clutch teeth 563 and 591 are engaged, as well as dog clutch teeth 601 and 371, therefore coupling the transmission out shaft 531 to rear disk unit 19. Via the single clutch system, from a disengaged state, rear end 440 of shaft 411 can now gradually be coupled to the power source, and transmission out shaft 531 will reach a speed of one third of the power source. The ratio of the variator 17 can now gradually be adjusted from the current 3:1 to 1:1 for the transmission out shaft 531 to reach the same speed as the power source. Note that dog clutch teeth 553 will now also rotate at the same speed as the power source due to the fixed coupling between rear end 550 and 440.

### Selector Unit 547 Position: Mode 2

By momentarily cutting the power source power electronically and disengaging the single clutch system, selector unit 547 can be moved to the position in FIG. 17D, representing mode 2, where dog clutch teeth 563 and 591 are engaged, as well as dog clutch teeth 601 and 553, therefore coupling the transmission output shaft 531 direct to the input shaft 529, rear end 550 in a 1:1 ratio. After selector unit 547 reaches above position, the single clutch system is re-engaged and power source power is restored. In this position the variator 17 does not transmit any power and is not coupled to transmission out shaft 531.

### Selector Unit 547 Position: Mode 3

With the selector unit 547 still in mode 2, the variator 17 is now adjusted from its current ratio of 1:1 to a ratio of 3:1. In this ratio the dog clutch teeth 583 of helical idler 573 will rotate at the same speed (1:1 ratio) as the power source since the variator current ratio of 3:1 and the 1:3 gear ratio (between helical gear 365 and helical idler 573 via mode shaft unit 527) result in a 1:1 ratio. Note there is ample time for variator 17 to do above ratio adjustment from 1:1 to 3:1 while power from the power source to the transmission out shaft 531 is being transmitted according to mode 2.

By momentarily cutting the power source power electronically and disengaging the single clutch system, selector unit 547 can be move to the position in FIG. 17E, representing mode 3, where dog clutch teeth 563 and 591 are engaged as well as dog clutch teeth 591 and 583 therefore coupling the transmission out shaft 531 to rear disk unit 19 via mode shaft unit 527. After selector unit 547 reaches above position, the single clutch system is re-engaged and the power source is restored, creating a 1:1 ratio between the power source and transmission out shaft 531 as explained above.

The ratio of the variator 17 can now gradually be adjusted from the current 3:1 to 1:1 for the transmission out shaft 531 to reach three times the speed of the power source (1:1 ratio of variator coupled to 1:3 ratio via mode shaft unit 527 to transmission out shaft 531).

### Reverse

With the single clutch system disengaged and the selector unit 547 in the neutral position of FIG. 17B and variator 17 in the 3:1 ratio, reverse spur gear 611 can be moved to the right from its position in FIG. 15B for its teeth to simultaneously engage the teeth of spur gear 541 and spur gear 587. When the single clutch system is now engaged the power source will drive the transmission out shaft 531 in a -3:1 ratio (opposite direction) via mode shaft unit 527. Note that the variator 17 can now gradually change its ratio to 1:1 to provide a variable reverse.

### Ratio Range

The complete ratio range of the transmission system of the invention 1 is generated by a low ratio, with selector unit 547 in mode 1 and variator 17 in a 3:1 ratio, resulting in a ratio from power source to transmission out shaft 531 of 3:1; to a high ratio where selector unit 547 is in mode 1 and variator 17 in a 1:1 ratio, resulting in a ratio from power source to transmission out shaft 531 of 1:3 - thus a ratio variation of 1:3 to 3:1 providing a ratio range of 9 which is in line with current high end automotive 9 and 10 speed dual clutch and automatic transmissions.

### Dual Clutch Embodiment

In this embodiment of the invention 1, the rear end 550 of direct input shaft 529 and rear end 440 of variator input shaft 411 are NOT coupled or fixed together, but coupled to a standard automotive dual clutch system (not shown) as is commonly found in dual clutch automotive transmissions. The dual clutch system allows for the selective disengagement or partially or full coupling of either rear end 550 or rear end 440 or both to the power source via two integrated wet or dry clutches, usually to an internal combustion engine in a typical automotive application. For explanation purposes, the first clutch of the dual clutch system is associated with rear end 440 and the second clutch with rear end 550. Further, in this embodiment, disk 551 and its dog clutch teeth 553 are eliminated from direct input shaft 529, while direct input shaft 529 is permanently fixed to output shaft 557 of transmission output shaft 531.

In the sections below only the difference in the operating modes with respect to the single clutch embodiment will be discussed while all other functioning is the same as in the single clutch embodiment.

### Selector Unit 547 Position: Mode1 (Dual Clutch)

With the selector 547 in the position of FIG. 17C and with the second clutch disengaged, via the first clutch engaging, rear end 440 can now gradually be coupled to the power source and transmission output shaft 531 will reach a speed of one third of the power source. The variator 17 can now be adjusted to a 1:1 ratio for the transmission output shaft 531 to reach the same speed as the power source

### Selector Unit 547 Position: Mode 2 (Dual Clutch)

The second clutch engages while simultaneously first clutch disengages to provide uninterrupted power transfer between the power source and the transmission output shaft 531. This clutch engagement/disengagement overlap is common practice in automotive dual clutch transmissions to provide uninterrupted power and torque transfer. After the above, selector unit 547 is moved to the position in FIG. 17D and thereafter the first clutch is engaged to keep the variator 17 running but not connected to the transmission output shaft 531. The variator 17 can now be adjusted from its current 1:1 ratio to a 3:1 ratio.

### Selector Unit 547 Position: Mode 3 (Dual Clutch)

After variator 17 reaches its 3:1 ratio, the first clutch is disengaged and right thereafter selector unit 547 is moved to the position in FIG. 17E. Thereafter the first clutch engages while simultaneously second clutch disengages to provide uninterrupted power transfer between the power source and the transmission out shaft 531.

In both the single clutch and dual clutch embodiments, the selector unit 547 in its transition between the respective modes are engaging dog clutch teeth, all rotating at the same speed and direction when the respective mode change takes place thus affecting synchronous mode changes. Synchronous mode changes have very significant advantages in automotive transmission implementation facilitating very quick shifting times and eliminating shock loads. In the case of the dual clutch embodiment, uninterrupted power and torque is maintained throughout all mode changes.

1. A CVT variator assembly which includes a first drive disk which is rotatable about a central axis in a first direction and which has a first disk face, the variator assembly comprising -
a variator arranged concentrically with the first disk and which includes -
a structure unit having a circular rim;
at least one follower housed within the structure unitand which is radially displaceable between the central axis and the rim, the follower including a driving roller which is mounted in friction drive contact with the first disk face, the follower further including at least one cam follower ;
at least one rotatable spiral cam arranged intermediate the drive disc and the structure unit and including a spiral cam cavity, the spiral cam being connected to the structure unit such that the roller and the cam follower at least partially protrudes through the spiral cam cavity with the cam cavity acting on the cam follower , the spiral cam being rotatable about the central axis to radially displace the roller for varying ratio of the variator, the spiral cam cavity being configured such that it provides continuous clearance for the roller uninterruptedly to engage the disk face frictionally for the whole of the radial distance between the central axis and the rim during rotation of the spiral cam; and
a variator input shaft.

2. The variator assembly according to claim 1 wherein the follower includes a first cam follower and a second cam follower,and wherein the spiral cam cavity defines a top cam and bottom cam, the arrangement being such that during rotation of the spiral cam in a first direction, the first cam follower engages and follows the top cam radially to displace the follower towards the central axis; while during rotation of the spiral cam in a second opposite direction, the second cam follower engages and follows the bottom cam radially to displace the follower towards the rim.

3. The variator assembly according to claim 1 wherein the structure unit includes a ratio drive arranged in mechanical cooperation with the spiral cam to rotate the cam between the first and second directions.

4. The variator assembly according to claim 3 wherein the spiral cam includes a set of gear teeth extending at least partially along the circumference of the spiral cam;and wherein the ratio drive includes a rotatable ratio input and a spiral drive,which is arranged in contact with the gear teeth of the spiral cam,the arrangement being such that rotation of the rotation input rotates the spiral drive,which in turn rotates the cam in the first and second directions.

5. The variator assembly according to claim 1 wherein the variator includes at least one rotatable radial shaft extending between the central axis and the rim and dimensioned for carrying the follower, the radial shaft being rotatable by means of the variator input shaft ,the radial shaft including a number of circumferentially equally spaced engaging formations extending the length of the shaft ;and wherein the roller includes a matching number of circumferentially equally spaced engaging formations which are complimentarily configured slidingly to engage the engaging formations of the shaft,the arrangement being such that the roller is rotated by the radial shaft while being radially displaceable between the central axis and the rim along the length of the shaft.

6. The variator assembly according to claim 5 wherein the follower includes a slider and wherein the structure unit includes at least one rib formation which is complimentarily configured to engage the slider,the arrangement being such that the slider on the follower slidingly engages the rib formation of the structure unit such that the follower is linearly displaceable along the length of the radial shaft.

7. The variator assembly according to claim 5 wherein the variator includes three radially equally spaced rotatable radial shafts and three followers which are each respectively carried by a radial shaft.

8. The variator assembly according to claim 1 which further includes
a second output disk, spaced from the first disk and which is rotatable about the central axis in a second direction which is opposite to the first direction and which has a second disk face opposing the first disk face, wherein the variator is arranged concentrically with and intermediate the first and second disks and wherein the driving roller is mounted in friction drive contact with the first disk face and the second disk face;
a spring unit for urging the disks towards each other so that a circular rim of the roller is frictionally engaged with the first and second disk faces whereby, upon rotation of the roller at a first rotational speed, the first disk and the second disk are respectively rotated and produce respective first and second rotational output drives; and
a coupling system which couples together the first and second disks to produce a combined output drive at a second rotational speed.

9. The variator assembly according to claim 1 which further includes a transmission input; variator output; transmission output; and a selector which alternately and selectively couples the variator output and transmission input to the transmission output in three modes, namely (i) firstly the selector directly couples the variator output and transmission output to each other to establish a first mode; (ii) secondly the selector directly couples the transmission input and transmission output to each other to establish a second mode; and (iii) thirdly the selector couples the variator output and transmission output through an intermediate gearing system to establish a third mode; wherein the selector operates synchronously across components rotating at the same speed in transitioning its different modes.

10. The variator assembly according to claim 1 which includes a transmission input; variator output; transmission output; a selector; and a dual clutch system including a first clutch and a second clutch, wherein the first clutch is coupled to the transmission input and the second clutch is coupled to the transmission output, and wherein the selector alternately and selectively couples the variator output to the transmission output in two ways, the arrangement being such that the dual clutch system and selector provides for three modes, namely (i) a first mode wherein the selector directly couples the variator output and transmission output to each other while the first clutch is engaged and the second clutch is disengaged; (ii) a second mode in which the first clutch is disengaged and the second clutch is engaged; and (iii) a third mode wherein the selector directly couples the variator output to the transmission output via an intermediary gear arrangement while the first clutch is engaged and the second clutch is disengaged; wherein the selector operates synchronously across components rotating at the same speed in transitioning its different modes.

11. The variator assembly according to claim 10 wherein the first and second clutch engagement and disengagement overlap to provide uninterrupted power and torque between the dual clutch system and transmission output during mode transitions.

12. The variator assembly according to claim 9 wherein the gear arrangement includes a selectively engageable reverse gear to provide for a reverse mode, in which the variator output is coupled to the gear arrangement such that the reverse gear is selectively engaged with the selector and the gear arrangement while the selector is disengaged from both the variator output and the transmission input.

13. (canceled)
